(19) United States
(12) Patent Application Publication
(10) Pub. No.: US 2008/0005955 A1
(43) Pub. Date: Jan. 10, 2008

(54) Fish Hook Extractor

(76) Inventor: Antonio Larcher, Muenchen (DE)

Correspondence Address: ROBERTS, MLOTKOWSKI & HOBBES, P. O. BOX 10064, MCLEAN, VA, 22102-8064, US

(21) Appl. No.: 11/568,871

(22) PCT Filed: Feb. 28, 2005
(86) PCT No.: PCT/DE05/00334

§ 371 Date: Nov. 9, 2006

(30) Foreign Application Priority Data
May 10, 2004 (DE) 10 2004 022 987.2

(51) Int. Cl. A01K 97/18

(52) U.S. Cl. 43/53.5

(57) ABSTRACT

There is provided a device for the extraction of a fish hook fixed to a fishing line from a mouth of a fish. The device comprises an extended retaining arm and a tubular hook holder, with a jointed connection to a free end of the retaining arm, which may be pivoted from a forward facing position for engaging the fish hook into a rearward facing release position by means of a pivot device, wherein a free inner cross section and a length of said the holder are such that a fish hook shaft fits in, wherein the hook holder is embodied over its entire length with a slot for introduction of the fishing line, wherein a handle is arranged at a rear end of the retaining arm in such a manner that the handle and the retaining arm are arranged in a pistol-like manner, and wherein in an area of an end of the retaining arm opposite to the free end a clamping device for the fishing line is provided.

### BACKGROUND OF THE INVENTION

1. Field of the Invention

The invention relates to a fish hook extractor.

2. Description of Related Art

The tools offered on the market for extracting a fish hook from the mouth of a fish are tongs with clamping jaws made as long as possible. Besides special tongs made of various metal alloys, tongs for electricians and artery forceps—as known from surgery—are also used.

In order to render the hook visible, jaw spreaders are offered to keep open the mouth of the fish.

In practice, the following happens.

The fish is hanging on the hook; it is slippery and wriggling. The jaw spreader is introduced. If the hook can be seen—usually it is still covered by the bait—one tries to seize the hook with the tongs. Provided that this is successful, there is no guaranty that the hook will remain seized by the tongs. Often several attempts are necessary. Once the hook is finally securely seized, it has to be released by a special sweep of the hand, and it has to be removed with caution from the still wriggling fish without hooking in again. The jaw spreader is an obstacle both for seizing the fish hook and for releasing and withdrawing the fish hook. Each unsuccessful attempt results in repetitions of the above actions involving additional burden both for the fish which, if “catch and release” is intended, will have more difficulty staying alive, and for the material of the hook, in particular for the anti-rust coating.

From GB 1 366 861 a pistol-shaped tool for removing a fish hook from the mouth of a fish is known, wherein at the front end of the pistol barrel a jaw arrangement is provided which can be closed by operation of a trigger biased towards the open position, in order to seize the hook. The jaw arrangement comprises a fixed jaw at the front end of the pistol barrel and a movable jaw which is pivotable relative to the fixed jaw by the trigger.

It is an object of the invention to provide a device for extracting a fish hook from the mouth of a fish, by which device the fish hook is approached automatically and is safely seized and released and wherein the danger of the hook hooking in again during removal from the mouth of the fish is eliminated.

### SUMMARY OF THE INVENTION

According to the invention, this object is achieved by a device according to claim 1.

The benefits which may be achieved by the invention reside in a sparing and fast release of the fish and in the simple handling of the fish hook extractor, since the fish hook extractor will be guided along the stretched fishing line directly to the fish hook. Since the bend of the hook in the retracted position of the hook holder is oriented towards the throat exit, re-hooking in cannot occur. Thus, the device can withdraw the hook from the throat without problems.

A special benefit is provided in particular by the optional capability of exchanging the hook holder. Since for each species of fish special fish hooks and hook sizes are used, different hook holders dimensioned according to the size of the fish hook can be mounted, so that only one basic device is needed. Thus, the basic device can be produced in large numbers and hence can be produced in a more cost-effective manner.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is an elevated view of a device according to the invention in the extended position of the hook holder;

FIG. 2 is a side-view of the device according to the invention in the extended position of the hook holder;

FIG. 3 is a side-view of the device according to the invention in the extended engaged position of the hook holder, with the hook holder itself being shown in a longitudinal central section and with the hook being shown stuck in the flesh of the mouth of the fish;

FIG. 4 is a side view of the device according to the invention in the retracted engaged position of the hook holder, with the hook holder itself being shown in a longitudinal central section and with the released hook being illustrated having the bend in the extraction direction;

FIG. 5 is a total view of the device according to the invention in the extended position of the hook holder;

FIG. 6 is a total view of the device according to the invention in the retracted position of the hook holder.

### DETAILED DESCRIPTION OF THE INVENTION

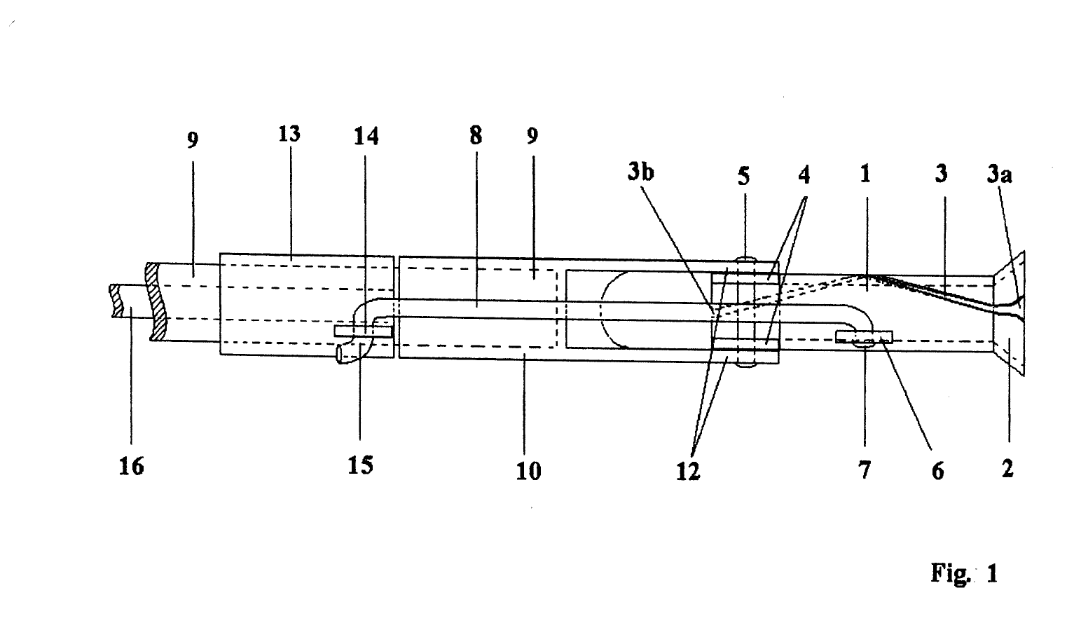

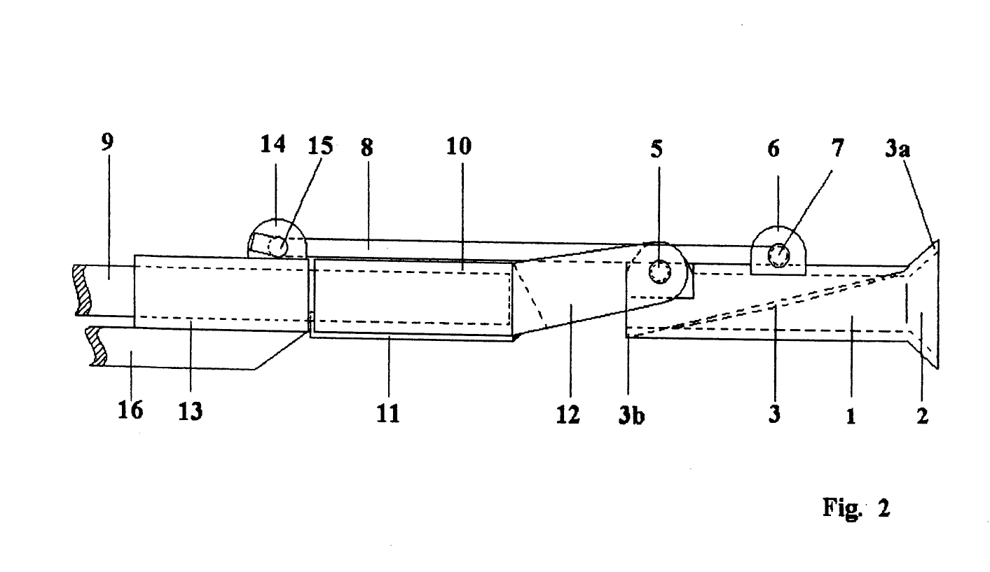

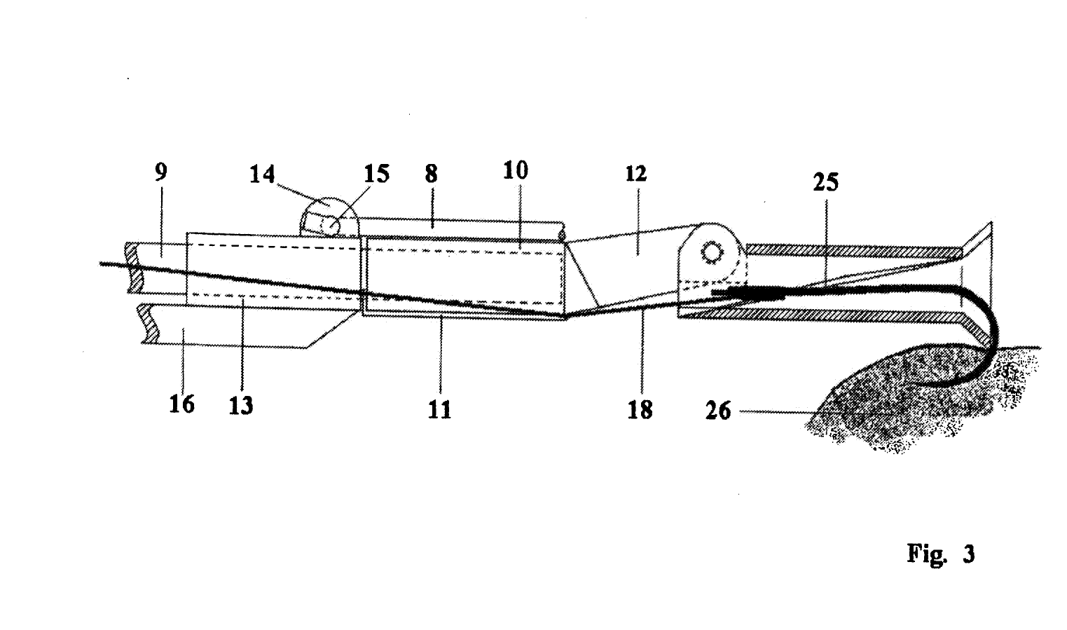

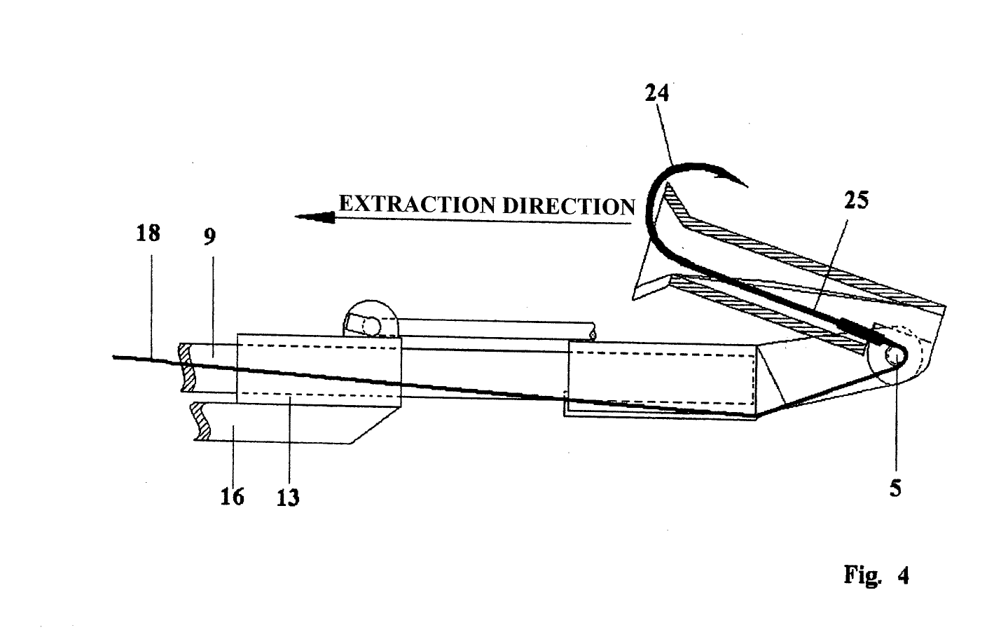

In FIG. 1 and FIG. 2 a hook holder 1 is shown, consisting of a metal tube having a funnel-shaped inlet 2 at the front end. The diameter and length of the metal tube are selected according to the size of the hook. The hook holder is provided with a slot 3 extending over the entire length. This slot 3 starts at the upper edge 3a of the funnel-shaped front inlet 2 of the hook holder 1 and extends spiral-like to the lower edge 3b at the rear end of the hook holder 1. The slot 3 may be right-handed rotating or left-handed rotating, depending on whether the device is for right-handed persons or for left-handed persons. The width of the slot is dimensioned according to the diameter of the fishing line. At the rear end of the hook holder 1 laterally two brackets 4 are arranged which run parallel to each other. These brackets 4 may be manufactured by cutting open the end of the tube or by welding to the tube jacket. The brackets 4 each are provided with a bore for receiving a hinge pin 5, which is oriented transverse to the axis of the hook holder 1.

At the top of the hook holder 1 a radially oriented extension is arranged which is mounted in the longitudinal direction and which comprises a bore which serves as a pivoting bearing 6 for the front head 7 of a connecting bar 8. The axis of the front head 7 is oriented transverse to the axis of the hook holder 1. The longitudinal distance between the axis of the hinge pin 5 of the hook holder 1 and the axis of the connecting rod head 7 define the required lever arm. The vertical distance between the axes of the hinge pin 5 and the connecting rod head 7 preferably corresponds to the sum of the radii of the hinge pin 5 and the connecting rod head 7.

A retaining arm 9—preferably a square bar—is provided with a separate head portion 10 to which the hook holder 1 is jointed. This head portion 10 preferably is exchangeable. However, also only the hook holder 1 may be arranged in an exchangeable manner. This involves the benefit that differently sized hook holders 1 can be used with the same basic device. In the illustrated embodiment the head portion 10 is connected to the remainder of the retaining arm by being inserted and it is secured by a snap-in spring clip 11. The head portion 10 of the retaining arm 9 comprises at its front end two brackets comprising transverse bores 12 for receiving the hinge pin 5 around which the hook holder 1 can be pivoted.

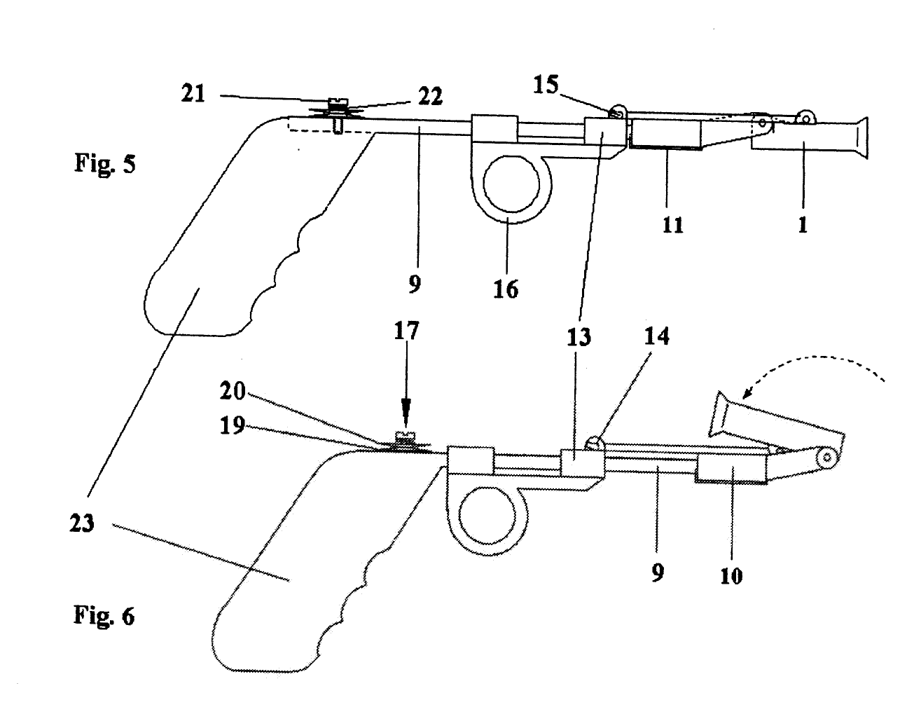

In FIG. 5 and FIG. 6 a slider member 13 can be seen which is mounted at the retaining arm 9. The slider member 13 is designed in such a manner that it is slideable along the entire length of the retaining arm 9 with low friction. At the front end of the slider member 13 an extension is provided parallel to the longitudinal axis of the retaining arm, which comprises a bore which serves as a pivoting bearing for the rear end 14 of the connecting rod. A trigger 16 is provided at the lower side of the rear end in order to move the slider member 13.

A clamping device 17 for a fishing line 18 is mounted at the rear end of the retaining arm 9. The clamping device 17 consists of two slightly convex discs 19, 20 which are pressed onto each other for receiving fishing lines 18 of various diameters. The lower disc 19 is fixed at the retaining arm 9 and the upper disc 20 is mounted by a screw 21 above the lower disc 19. A spring 22 below the screw head serves for fine adjustment of the pressure onto the upper disc 20 in order to safely hold the fishing line 18.

According to an alternative embodiment the clamping device may be formed, rather than by two slightly convex discs, by a single slightly convex disc which is pressed against a face of the retaining arm or the handle in an adjustable manner by a spring and a screw.

In order to operate the device, an ergonomically shaped handle 23 is fixed at the rear end of the retaining arm 9 in such a manner that the handle 23 and the retaining arm 9 are arranged in a pistol-like manner.

Preferably the device is made of such materials that it floats in water and hence is not lost if the user drops it into water inadvertently.

Operation of the Device:

The fishing line 18 is brought inwardly at the hook holder 1 in a diagonal manner through the spiral slot 3. Then it is held stretched parallel to the retaining arm 9. The hook holder 1 then is advanced with caution in the direction towards the hook 24, with the fishing line 18 acting as a guide, until the fish hook leg 25 is received. The need for special devices for obtaining sight into the mouth of the fish thereby is eliminated. Thereafter the stretched fishing line 18 is clamped between the slightly convex discs 19, 20 by a half-turn. From now on the device is operable with one hand. This is particularly beneficial for strongly wriggling fish or for strongly rolling boats.

If now the trigger 16 of the slider member 13 is pulled, the hook holder 11 is tilted by about 150 degrees. Thereby the hook 24 is automatically released from the mouth of the fish. The hook 24 now is located with the bend facing the exit, it hence has no possibility to hook-in again, and it is extracted without problems.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1-16. (canceled)

17. A device for the extraction of a fish hook fixed to a fishing line from a mouth of a fish, comprising an extended retaining arm and a tubular hook holder, with a jointed connection to a free end thereof, which may be pivoted from a forward facing position for engaging said fish hook into a rearward facing release position by means of a pivot device, wherein a free inner cross section and a length of said hook holder are such that a fish hook shaft fits in, wherein said hook holder is embodied over an entire length thereof with a slot for introduction of said fishing line, wherein a handle is arranged at a rear end of said retaining arm in such a manner that said handle and said retaining arm are arranged in a pistol-like manner, and wherein in an area of an end of said retaining arm opposite to said free end a clamping device for said fishing line is provided.

18. The device of claim 17, wherein an engagement end of said hook holder is funnel-shaped.

19. The device of claim 17, wherein said hook holder is jointed to said free end of said retaining arm by means of a hinge pin.

20. The device of claim 19, wherein said hook holder is exchangeable.

21. The device of claim 20, wherein a head portion which can be inserted at a front end of said retaining arm is connected to a remainder of said retaining arm and is secured by means of a snap-in spring clip, said head portion comprising at its front end two brackets having transverse bores for receiving said hinge pin around which said hook holder may be pivoted.

22. The device of claim 21, wherein said pivot device comprises a slider member which is guided along said retaining arm and which is jointed to said hook holder via a connecting rod.

23. The device of claim 22, wherein extensions are arranged at said slider member and said hook holder, at which extensions pivoting bearings for said connecting rod are arranged.

24. The device of claim 23, wherein a pivoting bearing for a front head of said connecting rod is arranged at an axial distance from said hinge pin.

25. The device of claim 22, wherein said pivoting bearing for said connecting rod front head and said hinge pin are arranged in such a manner that a vertical distance of both axes thereof corresponds to a sum of the radii of said hinge pin and said connecting rod head.

26. The device of claim 22, characterized in that a trigger is arranged at said slider member.

27. The device of claim 17, wherein said clamping device comprises two slightly convex discs which are pressed onto each other by means of a spring and a screw in an adjustable manner.

28. The device of claim 17, wherein said clamping device comprises a slightly convex disc which is pressed against a face of said retaining arm or a handle by means of a spring and a screw in an adjustable manner.

29. The device of claim 17, wherein the slot is designed right-handed rotating or left-handed rotating in a helical manner.

30. The device of claim 17, wherein the device is manufactured of such materials that it floats in water.
